(19) United States
(12) Patent Application Publication
(10) Pub. No.: US 2003/0033147 A1
(43) Pub. Date: Feb. 13, 2003

(54) Method and apparatus for coordinating text and audio events in a digital talking book

(75) Inventors: Tom Charles McCartney, Missoula, MT (US); Joseph Woodill, Lawrenceville, NJ (US); James Pritchett, Princeton, NJ (US); David Kozemchak, Hamilton, NJ (US); Jennifer Grant, East Windsor, NJ (US); Alphonso Gaines, East Orange, NJ (US)

Correspondence Address: Thomason, Moser & Patterson, LLP, Suite 100, 595 Shrewsbury Avenue, Shrewsbury, NJ, 07702, US

(73) Assignee: Recording for the Blind & Dyslexic Incorporated

(21) Appl. No.: 09/878,032

(22) Filed: Jun. 8, 2001

(51) Int. Cl. G10L 13/08

(52) U.S. Cl. 704/260

(57) ABSTRACT

Apparatus and method for coordinating independently-produced text and audio clip data and for providing an efficient method of making the adjustments needed to produce a properly coordinated and constructed digital talking book. The present method employs synchronization files, e.g., a book project management (BPM) file and a Time Stamp Data (TSD) file in coordinating the text and audio clip data.

The present invention relates to an apparatus and concomitant method for coordinating the text and audio events in a digital talking book. Specifically, the present invention provides a method for synchronizing text elements of a book with specific previously recorded audio passages stored on an analog storage medium. In performing the synchronization function, the present invention also provides a flexible graphical user interface that allows a user to easily review and modify the synchronized elements.

### BACKGROUND OF THE DISCLOSURE

As digital technologies continue to gain wide acceptance, a vast amount of previously stored information must be adapted into the new digital standards. Such previously stored information includes a vast library of existing analog-recorded books. To preserve the huge investment in such analog recordings, these recordings are being converted into digital format for implementation such as the Digital Talking Book (DTB) in accordance with the “Daisy” consortium specifications.

Unfortunately, among other requirements, the Daisy specification requires that each text element provides a point of synchronization (i.e., “synchronizable element”) be associated with a specific recorded audio passage (“audio clip”). In a Daisy DTB recording system, this synchronization information can be captured at the time of recording. However, in a system designed to produce Daisy DTBs from existing recorded books on analog tape, this approach is very labor intensive and impractical. Specifically, in such a system, the text and audio components of the Digital Talking Book are produced independently of one another and must be married as a separate process. This process is very labor intensive and the enormity of the task is further amplified with the existence of hundreds of thousands of existing analog recorded books.

Therefore, there is a need for an apparatus and method for coordinating independently-produced text and audio clip data and for providing an efficient method of making the adjustments needed to produce a properly coordinated and constructed digital talking book.

### SUMMARY OF THE INVENTION

An embodiment of the present invention is an apparatus and method for coordinating independently-produced text and audio clip data and for providing an efficient method of making the adjustments needed to produce a properly coordinated and constructed digital talking book. The present invention employs synchronization files, e.g., a book project management (BPM) file and a Time Stamp Data (TSD) file in coordinating the text and audio clip data.

In operation, various files, e.g., BPM, TSD, audio and HTML files are initially loaded. Next, synchronizable elements in the text are correlated with the audio clips. For example, if a book section is opened for the first time, the present invention will attempt to correlate the synchronizable elements in the HTML with the audio clips identified in the TSD. The audio clips in the TSD are identified as being either for heading (e.g. chapter) announcements or page announcements.

Next, the present invention builds links between the HTML and TSD documents internally by first correlating all heading elements to heading TSD events, and then correlating the page elements that occur between those headings with the page events in the corresponding section of the TSD. This auto-linking feature is designed to serve as a “rough cut” of the text-audio coordination.

Next, the present invention adds graphics to the HTML for display. Specifically, for each synchronizable element in the HTML, the present invention inserts images in its internal representation of the HTML. These images identify whether or not the element has been linked to a TSD event. Similarly, the present invention adds graphics to the internal representation of the audio event data from the TSD file. These images identify whether or not the audio event has been linked to a synchronizable element. This combination of images and information provides a user friendly graphical interface to be deployed, where the HTML (with the embedded graphics) is displayed on one side and a list of all TSD events (with the embedded graphics) are displayed on the other. This allows the operator to quickly tell at a glance which text elements need to be linked to audio events.

Finally, the present invention allows the accuracy of the links to be verified when the operator activates, e.g., clicks on a linked HTML element, thereby causing the associated audio clip to be played. This allows the operator to verify that the HTML element has been correctly linked. Similarly the operator can click on an event in the TSD list to hear the audio clip represented by that event while the associated HTML element (if any) is highlighted. If the accuracy of the links requires adjustment, the present invention allows various edit functions to be performed, e.g., breaking links, adding links, grouping links, adjusting timing of TSD event, creating/deleting TSD events editing HTML elements.

### BRIEF DESCRIPTION OF THE DRAWINGS

The teachings of the present invention can be readily understood by considering the following detailed description in conjunction with the accompanying drawings, in which:

FIG. 1 depicts a block diagram of the present invention for coordinating independently-produced text and audio clip data to produce a properly coordinated and constructed digital talking book;

FIG. 2 depicts a block diagram of the data structure of a book project management (BPM) file of the present invention;

FIG. 3 depicts a block diagram of the data structure of a time stamp data (TSD) file of the present invention;

FIG. 4 depicts a block diagram of the data structure of a track announcement data (TAD) file of the present invention;

FIG. 5 is a screen shot of the graphical user interface of the present invention; and

FIG. 6 depicts a block diagram of a flowchart of the method of the present invention for coordinating independently-produced text and audio clip data to produce a properly coordinated and constructed digital talking book.

To facilitate understanding, identical reference numerals have been used, where possible, to designate identical elements that are common to the figures.

### DETAILED DESCRIPTION

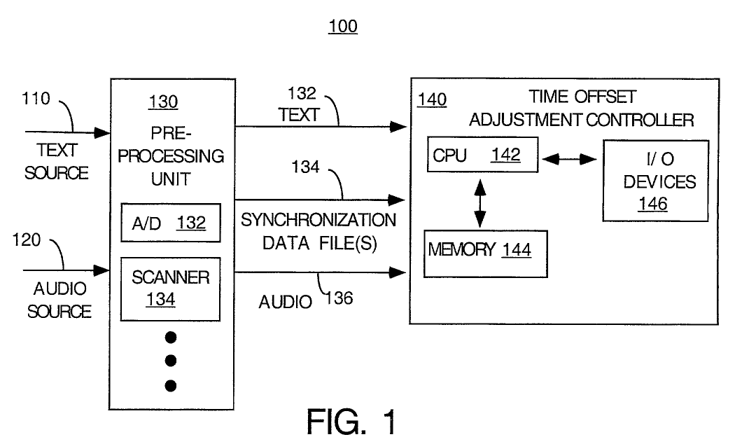

The present invention provides an apparatus and method for coordinating independently-produced text and audio clip data to produce a properly coordinated and constructed digital talking book. Specifically, FIG. 1 illustrates a block diagram of the present invention having a preprocessing unit 130 and a time offset adjustment controller (TOAC) 140.

In operation, a source of text data on path 110 and a source of audio data on path 120 are pre-processed by the pre-processing unit 130 into appropriate formats. For example, the text data may comprise one or more text documents stored in a word processor format, (e.g., Word or WordPerfect). Alternative, the text data may comprise pages of text that are to be converted into digital form via a scanner 134. In one embodiment, the pre-processing unit 130 converts the text data on path 110 into a preferred format, i.e., marked-up text file(s), on path 132 for processing by the time offset adjustment controller (TOAC) 140. Specifically, the text data on path 132 can be presented in either HyperText Markup Language (HTML) or XML. HTML pages may include information structures known as “hypertext” or “hypertext links.” Hypertext, within the context of the present invention, is typically a graphic or textual portion of a page which includes a parameter contextually related to an audio element. By accessing a hypertext link, an audio clip associated with that hypertext link is retrieved and played.

The marked-up text files may contain the full text of the original printed book, or may consist of a subset of this text. For example, one typical type of book produced through analog-to-digital conversion contains only the major headings and page numbers in the text portion. This has been called a “Table of Contents” or “TOC” book.

The audio data on path 120 is typically independently-produced audio clips that were previously recorded in an analog format. The preprocessing unit 130 can also convert this audio data on path 120 into a number of different formats, e.g., MP3, WAV and the like, on path 136 for processing by the time offset adjustment controller (TOAC) 140. The audio files typically contain the full-recorded text of the printed book.

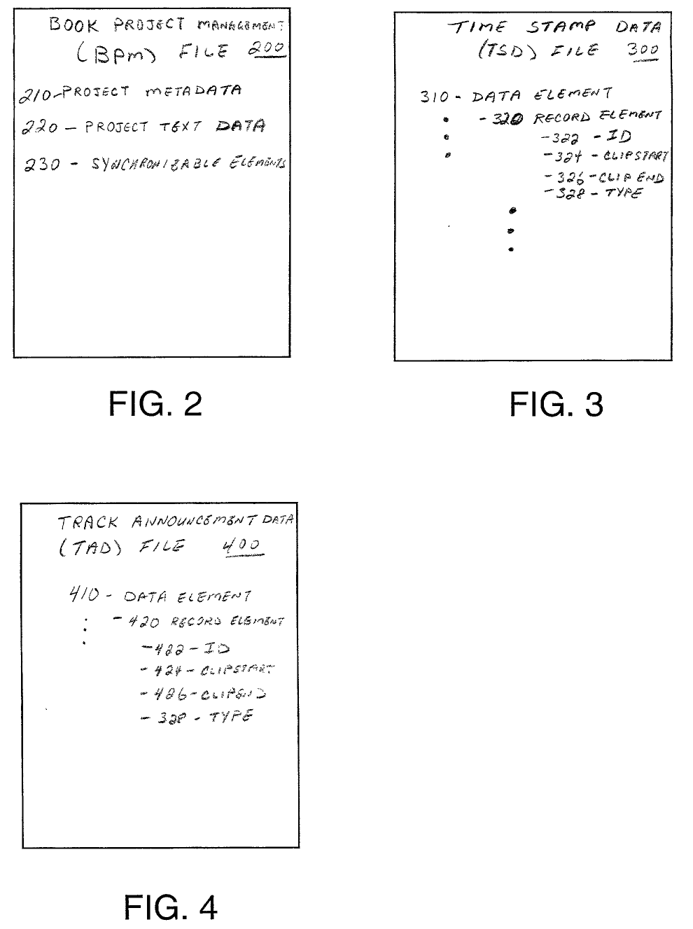

Finally, one or more synchronization data files are also generated by the pre-processing unit 130 on path 134. These synchronization data files are used by the time offset adjustment controller (TOAC) 140 to synchronize and coordinate independently-produced text and audio clip data to produce a properly coordinated and constructed digital talking book. The data structures for these synchronization data files are illustrated in FIGS. 2-4 and are described below. Examples on the methods for generating these synchronization data files are disclosed in US patent application entitled “Method And Apparatus For Converting An Analog Audio Source Into A Digital Format” with attorney docket “M&M/003”, which is herein incorporated by reference and is filed simultaneous herewith.

Thus, it should be noted that pre-processing unit 130 comprises a plurality of modules, e.g., an analog-to-digital (A/D) converter 132, a scanner 134 and any other modules that may be necessary to generate the text files, audio files and synchronization data files on paths 132-136. In fact, the preprocessing unit 130 can be implemented using a general purpose computer (not shown) having a central processing unit, a memory and various I/O devices (e.g., similar to that of the TOAC 140 as described below).

In one embodiment, the time offset adjustment controller (TOAC) 140 is implemented using a general purpose computer having a central processing unit (CPU) 142, a memory 144, and various Input/Output (I/O) devices 146. The input and output devices 146 may comprise a keyboard, a mouse, a modem, a camera, a camcorder, a video monitor, any number of imaging devices or storage devices, including but not limited to, a tape drive, a floppy drive, a hard disk drive or a compact disk drive. The general purpose computer allows a user to produce a properly coordinated and constructed digital talking book using the files received on paths 132-136.

In the preferred embodiment, various functions of the time offset adjustment controller (TOAC) 140 as discussed below are implemented (in part or in whole) by a software application that is loaded from a storage device and resides in the memory 144 of the computer. As such, the time offset adjustment controller (TOAC) 140 and associated methods and/or data structures illustrated in FIGS. 2-4 of the present invention can be stored on a computer readable medium. Finally, it should be noted that the general purpose computer of the time offset adjustment controller 140 should be broadly interpreted to include one or more personal computers, servers, main frames and the like.

FIG. 2 illustrates a block diagram of the data structure 200 of a first synchronization file, i.e., a “book project management” (BPM) file of the present invention. For the purposes of the TOAC, a “book-project” consists of all the files required to construct a single DTB. The data required to manage the entire book project is stored in the BPM file. The TOAC uses a software application, e.g., an XML application, for processing these data files. The document type definition for the BPM file is given in the Appendix. The BPM contains: (1) project metadata 210, (2) a list of the project text files 220, and (3) information on which text elements 230 are synchronizable and/or navigable.

Project metadata comprises certain data about a DTB and its source printed book that are required as part of the Daisy DTB specification. The BPM contains a list of these metadata items stored in its <meta_entry> elements. Specifically, project metadata represents information about the talking book and the print version from which it was derived. This includes items such as title, author, original publisher, copyright date, language, ISBN number of a book, Daisy specification and etc.

More specifically, metadata items are items that are used to provide additional information about the document in question, but that are not necessarily part of the content of the document. For example, the ISBN number of a book would be included as metadata of a document, but it is not itself part of the content of the document. These metadata items are designed to be used by software applications for providing advanced cataloging, bibliographic and archival information. The metadata items are primarily used for indexing documents, and for providing search functionality for information that is not direct content of the document. Specification such as DAISY may provide a list of metadata items that are required to produce a DAISY compliant talking book.

The BPM file includes a list of the marked-up text files that make up the book. These are given in the <file_entry> elements, which are listed in the order that they are to be present in the DTB. Various attributes can be employed to define the name of the source text file, the path or location of the source text file and the type of the source text file (e.g., HTML or XML).

Finally, BPM contains information that identifies synchronizable or navigation elements. Specifically, the marked-up text by itself does not contain within it any specific indication of where synchronization is to occur with the audio data. However, the markup standards that are used, provide a means of identifying certain classes of elements (headings, pages, etc.). The BPM then contains identifications of which classes of elements are to be considered points of synchronization. These are listed in the <smil_sync> element, which is a list of <sync_entry> elements identifying text markup types. Not all items that are synchronized with the text may be used as high-level navigation points. The <ncc_sync> element is a list of <sync_entry> elements that identify the text elements that will be included in the Navigation Control Center (NCC) that is part of every Daisy DTB. The <ncc_sync> list is always a subset of the <smil_sync> list.

FIG. 3 depicts a block diagram of the data structure 300 of a second synchronization file, i.e., a “time stamp data” (TSD) file of the present invention. Within each audio recording, there are a number of points which are to be synchronized with specific elements in the marked-up text. The information about these time points is stored in separate data files. The TOAC uses a software application, e.g., an XML application, for processing these time stamp data (TSD) files. The document type definition (DTD) for a TSD file is given in the Appendix.

The TSD file 300 contains one or more <data> elements 310, where each data element contains the time data for a single audio file. Various attributes can be employed with the data element 310 for defining the name of the audio file and the amount of recorded time in the audio file. Each data element contains at least one record element 320 that identifies elements of audio that are associated with a given navigation point.

Specifically, each audio clip is expressed as a <record>element 320, containing a unique ID 322, the clip starting time 324, the clip ending time 326 and type 328. The ID attribute 322 holds a value of the associated navigation point in the source text file. The Starttime attribute indicates the time as to where the associated audio segment begins. The Endtime attribute indicates the time as to where the associated audio segment ends. The type attribute indicates whether the audio is encapsulated (i.e., stops exactly at end point) or open-ended (i.e., continues until the start time of the next event exactly).

Each <data> element can contain one or more <record> elements. The order of the <data> and <record> elements within the TSD file represents the order in which the clips are to be presented in the DTB. In one embodiment of the TOAC 140, each TSD file is associated with one and only one marked-up file.

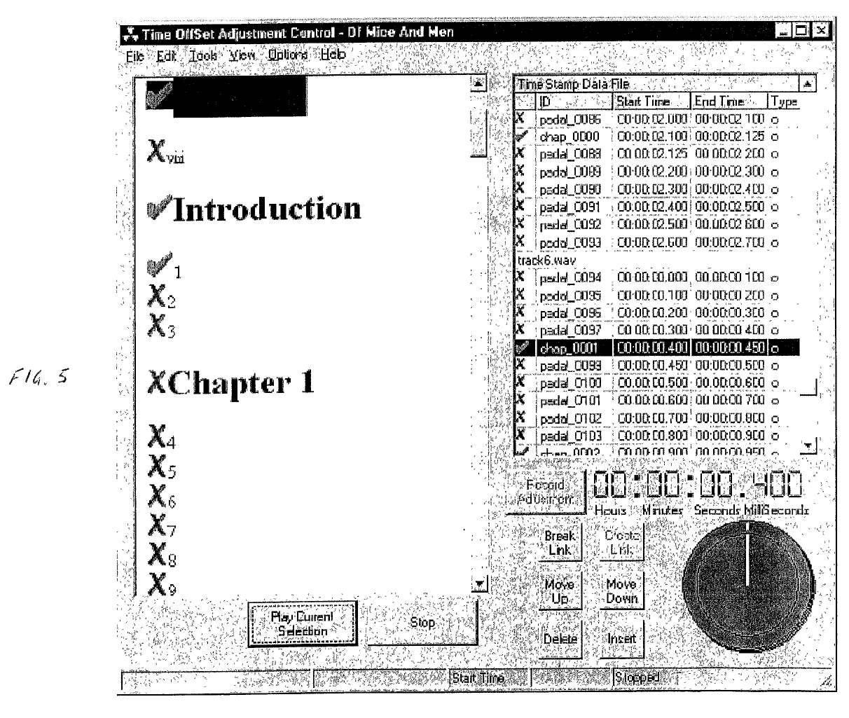

FIG. 4 depicts a block diagram of the data structure 400 of a third synchronization file, i.e., a track announcement data (TAD) file of the present invention. Specifically, additional audio timing data is stored in the TAD file. This file uses the same XML application as the TSD files to store information about the recorded analog track announcements. These announcements were required in the original analog product, but have no specific use in a DTB. However, storing the track announcements from the DTB, allows them to remain in the digital audio files so that they can be used for future digital-to-analog conversions. The TAD file stores timing information that describes the location of the track announcements in the original analog product. Each entry in the TAD file describes a single audio clip that encompasses one of these announcements. This information can be used when creating the DTB SMIL files to omit playback of these announcements in the digital product without actually deleting the announcements from the audio files themselves. Thus, the audio files remain an exact image of the original analog product tracks. This is desirable should one wish to use these files as digital masters for future analog cassette production.

The TAD or Track Announcement Data file is a file that uses the exact same file and data structure as the Time Stamp Data file, which is described above and in the Appendix. The TAD file provides a location to store information about the announcements added during the analog recording process. The announcements do not include any of the content of the text, and are used solely for user reference information at the beginning and end of each track of recording. An example of a Track Announcement would be “Tape 2, Track 3, Pages 123 through 145.” This information is necessary for user navigation in the analog format, and is not applicable to the digital format. By capturing this information during Analog-to-Digital conversion, and separating it from the actual content of the book, future Digital-to-Analog conversion for mastering tapes from a digital archive is simplified. By separating this information from the content of the book, the present invention is able to leave it in the audio files, but avoid those portions of the audio during playback.

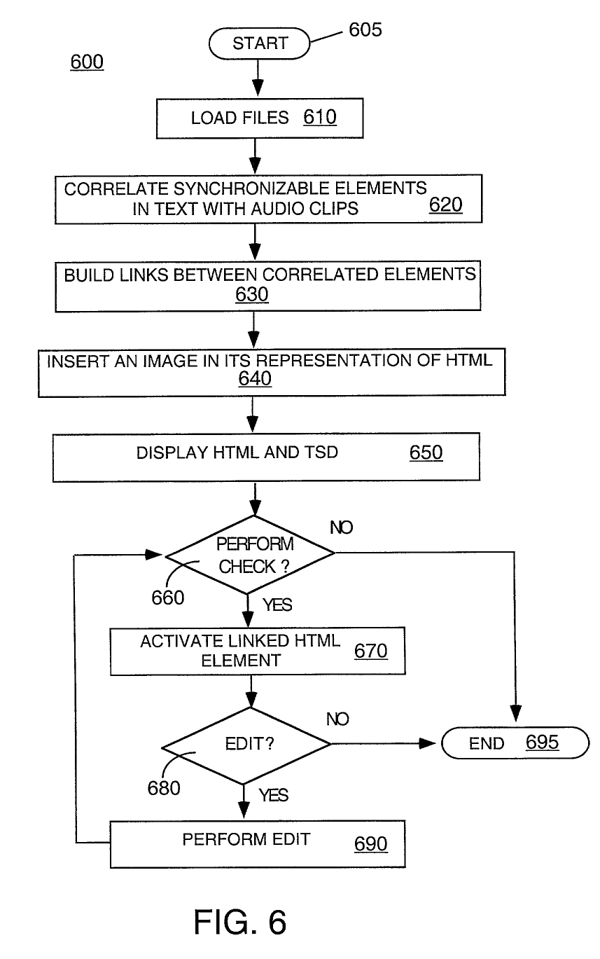

FIG. 6 depicts a block diagram of a flowchart of the method 600 of the present invention for coordinating independently-produced text and audio clip data to produce a properly coordinated and constructed digital talking book. Method 600 starts in step 605 and proceeds to step 610.

In step 610, method 600 loads various files, e.g., BPM, TSD, audio and HTML files. Namely, it is assumed that all the audio, text, and synchronization files, e.g., BPM, TSD and TAD files for the book project have been generated beforehand by some operations. The BPM file can be created by hand from within the TOAC. For example, the user simply fills in a form with the appropriate metadata, text file, and synchronizable element information. Alternatively, the BPM can be created beforehand by some other means, e.g., via the preprocessing unit 130 and simply opened by the TOAC operator.

It should be noted that the TOAC can operate on one “book section” at a time. A book section may consist of a single marked-up text file, the TSD file associated with this text file, and all the audio files referenced by the TSD file. The TOAC identifies book sections by parsing the file list in the BPM. After loading the BPM, the operator may select a book section to work with and open it.

Once the relevant files are opened, method 600 correlates synchronizable elements in the text with the audio clips in step 620. Namely, if this is the first time that this book section has been opened, the TOAC will attempt to correlate the synchronizable elements in the HTML with the audio clips identified in the TSD. The audio clips in the TSD are identified as being either for heading (e.g. chapter) announcements or page announcements. The HTML should include heading and page elements, identified as given in the Daisy DTB specification.

In step 630, method 600 builds links between the HTML and TSD documents internally by first correlating all heading elements to heading TSD events, and then correlating the page elements that occur between those headings with the page events in the corresponding section of the TSD. This auto-linking feature is designed to serve as a “rough cut” of the text-audio coordination.

More specifically, the TOAC represents the links between HTML elements and TSD events by assigning identical ID attributes to each. The use of identical IDs allows the TOAC to rebuild its internal table of links automatically when a book section is reopened for further editing. This use of identical IDs is also how the play back software is able to associate a specific text element with its associated audio.

In step 640, method 600 adds graphics to the HTML for display. Specifically, for each synchronizable element in the HTML, the TOAC inserts an image in its internal representation of the HTML. This image identifies whether or not the element has been linked to a TSD event. Similarly, for each TSD event, the TOAC inserts an image in its internal representation of the data. This image identifies whether or not the audio event has been linked to a synchronizable element. In one implementation, linked elements and TSD events are identified by a green checkmark and unlinked elements and TSD events are identified by a red “X”. This allows the operator to quickly tell at a glance which text elements need to be linked to audio events. However, it should be noted that the present invention is not so limited and that other graphical schemes or symbols can be adapted to the present invention.

In step 650, method 600 displays the HTML and TSD. A screen display of this implementation is provided in FIG. 5, where the HTML (with the TOAC-embedded graphics) is displayed on one side and a list of all TSD events are displayed on the other.

In step 660, method 600 queries whether the accuracy of the links are to be checked. If the query is negatively answered, then method 600 ends in step 695. If the query is positively answered, then method 600 proceeds to step 670.

In step 670, accuracy of the links can be verified when the operator activates, e.g., clicks on a linked HTML element, causing the TOAC to begin playing the associated audio clip. This allows the operator to verify that the HTML element has been correctly linked. Similarly the operator can click on an event in the TSD list to hear the audio clip represented by that event while the associated HTML element (if any) is highlighted.

In step 680, method 600 queries whether an edit function is to be performed. If the query is negatively answered, then method 600 ends in step 695. If the query is positively answered, then method 600 proceeds to step 690 where various edit functions can be performed.

Specifically, the operator can change the data in a book section in many ways, including:

a. Breaking links: If an HTML element is incorrectly linked to a TSD event, the operator can break that link. The TOAC will change the display of the associated graphic accordingly.

b. Adding links: The operator can link an unlinked HTML element to a TSD event. The TOAC will change the display of the associated graphic accordingly.

c. Group linking/unlinking: If a continuous series of HTML elements are to be linked to a continuous series of TSD events, the operator can select these two groups and link them in a single operation. Similarly, if a series of HTML elements/TSD events are improperly linked, they can be selected and unlinked in a single operation.

d. Adjust timing of TSD events: If an audio clip does not start and/or end at the correct time to present the heading or page announcement, these times can be adjusted by the operator. This can be accomplished by an on-screen control dial, or by entering the timings directly.

e. Create/delete TSD events: If the audio clip for a synchronizable element is not identified in the TSD, a new event can be created at any point within the TSD to record this information. Similarly, unnecessary TSD events can be deleted form the list.

f. Create/delete HTML elements: If the input HTML is missing one or more synchronizable items, the operation can insert these at any point in the HTML file. In the case of page elements, the TOAC allows the operator to enter a range of these in one operation. The HTML elements so added can then be linked to the appropriate TSD events. Similarly, HTML elements which are not needed can be deleted from the HTML file.

g. Edit HTML elements: If the text of an HTML element is incorrect (e.g., a page number is incorrect, or a heading contains a misspelling), the operator can edit the text of this element.

After all editing functions are performed, method 600 returns to step 660, where accuracy can be performed again as described above. Otherwise, method 600 ends in step 695.

It should be noted that after the operator has finished making all necessary adjustments to a specific book section, he or she can create a SMIL (Synchronized Multimedia Integration Language) file for this book section. The Daisy DTB specification requires the use of SMIL as the format for text-audio synchronization data. The TOAC includes the ability to generate SMIL files from the TSD files.

After all the book sections are completed and all SMIL files have been created, the operator can create an NCC for the DTB. The NCC is required by the Daisy DTB specification. The TOAC includes the ability to generate an NCC based on data found in the BPM and marked-up text files. The NCC, SMIL, marked-up text, and audio files together will now form a Daisy-compliant DTB.

The DTDs for both the Book Project Management file and the Time Stamp Data file are provided in the Appendix below. Descriptions are also provided to assist the reader in understanding the DTDs. It should be noted that specific structures of the DTDs are implemented in one embodiment of the present invention. As such, those skilled in the art will realize that specific structures of the DTDs can be adjusted in accordance to a particular implementation and should not be interpreted to limit the present invention.

Although various embodiments which incorporate the teachings of the present invention have been shown and described in detail herein, those skilled in the art can readily devise many other varied embodiments that still incorporate these teachings.

[image]

[image]

[image]

[image]

[image]

[image]

[image]

[image]

[image]

What is claimed is:

1. Method for constructing a digital talking book from text data and audio data, said method comprising the steps of:
(a) accessing a first synchronization file that identifies a plurality of synchronizable elements of the text data;
(b) accessing a second synchronization file that identifies a plurality of time points of the audio data; and
(c) building links between said identified synchronizable elements of the text data with said identified time points of the audio data.

2. The method of claim 1, further comprising the step of:
(d) inserting a graphical representation for each of said identified synchronizable elements of the text data.

3. The method of claim 1, further comprising the step of:
(d) inserting a graphical representation for each of said identified time points of the audio data.

4. The method of claim 2, wherein said graphical representation indicates whether its associated synchronizable element is synchronized.

5. The method of claim 1, further comprising the step of:
(d) displaying both of said identified synchronizable elements of the text data and said time points of the audio data on a display.

6. The method of claim 5, further comprising the step of:
(e) clicking on one of said synchronizable elements on said display to play said linked associated audio data.

7. The method of claim 5, further comprising the step of:
(e) clicking on one of said synchronizable elements on said display to display said linked associated text data as being highlighted.

8. The method of claim 5, further comprising the step of:
(e) performing an editing function to adjust the synchronization between said identified synchronizable elements of the text data with said identified time points of the audio data.

9. The method of claim 8, wherein said editing function comprises breaking a link.

10. The method of claim 8, wherein said editing function comprises adding a link.

11. The method of claim 8, wherein said editing function comprises grouping a link.

12. The method of claim 8, wherein said editing function comprises adjusting a time point.

13. The method of claim 8, wherein said editing function comprises creating a time point.

14. The method of claim 8, wherein said editing function comprises deleting a time point.

15. The method of claim 8, wherein said editing function comprises creating and inserting a synchronizable element.

16. The method of claim 8, wherein said editing function comprises deleting a synchronizable element.

17. A computer-readable medium having stored thereon a plurality of instructions, the plurality of instructions including instructions which, when executed by a processor, cause the processor to perform the steps comprising of:
(a) accessing a first synchronization file that identifies a plurality of synchronizable elements of the text data;
(b) accessing a second synchronization file that identifies a plurality of time points of the audio data; and
(c) building links between said identified synchronizable elements of the text data with said identified time points of the audio data.

18. The computer-readable medium of claim 17, further comprising the step of:
(d) inserting a graphical representation for each of said identified synchronizable elements of the text data.

19. The computer-readable medium of claim 17, further comprising the step of:
(d) inserting a graphical representation for each of said identified time points of the audio data.

20. The computer-readable medium of claim 18, wherein said graphical representation indicates whether its associated synchronizable element is synchronized.

21. The computer-readable medium of claim 18, further comprising the step of:
(d) displaying both of said identified synchronizable elements of the text data and said time points of the audio data on a display.

22. The computer-readable medium of claim 21, further comprising the step of:
(e) clicking on one of said synchronizable elements on said display to play said linked associated audio data.

23. The computer-readable medium of claim 21, further comprising the step of:
(e) clicking on one of said synchronizable elements on said display to display said linked associated text data as being highlighted.

24. The computer-readable medium of claim 21, further comprising the step of:
(e) performing an editing function to adjust the synchronization between said identified synchronizable elements of the text data with said identified time points of the audio data.

25. Apparatus for constructing a digital talking book from text data and audio data, said apparatus comprising:
means for accessing a first synchronization file that identifies a plurality of synchronizable elements of the text data and for accessing a second synchronization file that identifies a plurality of time points of the audio data; and
means for building links between said identified synchronizable elements of the text data with said identified time points of the audio data.

26. The apparatus of claim 25, further comprising:
means for inserting a graphical representation for each of said identified synchronizable elements of the text data.

27. The apparatus of claim 25, further comprising:
means for inserting a graphical representation for each of said identified time points of the audio data.

28. The apparatus of claim 26, wherein said graphical representation indicates whether its associated synchronizable element is synchronized.

29. The apparatus of claim 25, further comprising:
means for displaying both of said identified synchronizable elements of the text data and said time points of the audio data on a display.

30. The apparatus of claim 29, further comprising:
means for clicking on an synchronizable element on said display to play said linked associated audio data.

31. The apparatus of claim 29, further comprising:
means for clicking on an synchronizable element on said display to display said linked associated text data as being highlighted.

32. The apparatus of claim 29, further comprising:
means for performing an editing function to adjust the synchronization between said identified synchronizable elements of the text data with said identified time points of the audio data.

33. A computer readable medium having stored thereon a data structure for assisting in the construction of a digital talking book from text data and audio data, said data structure comprising:
a project metadata field;
a project text data field; and
a synchronizable element field.

34. A computer readable medium having stored thereon a data structure for assisting in the construction of a digital talking book from text data and audio data, said data structure comprising:
a data element field, wherein said data comprises at least one record element field, wherein said at least one record element field comprises:
a identification field;
a starttime field;
an endtime field;
and a type field.
